(19) United States
(12) Patent Application Publication
(10) Pub. No.: US 2004/0261817 A1
(43) Pub. Date: Dec. 30, 2004

(54) Foreign matter removing apparatus, substrate treating apparatus, and substrate treating method

(75) Inventors: Hiroyuki Araki, Kyoto (JP); Kazuo Nakajima, Kyoto (JP); Kaoru Shimbara, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/873,017

(22) Filed: Jun. 21, 2004

(30) Foreign Application Priority Data
Jun. 27, 2003 (JP) 2003-184524
Mar. 30, 2004 (JP) 2004-100548

(51) Int. Cl. B08B 3/00

(52) U.S. Cl. 134/2; 134/21; 134/33; 134/36; 134/102.1; 134/153; 134/157; 134/902

(57) ABSTRACT

A foreign matter removing apparatus for removing foreign matter from a surface of a substrate. The apparatus is provided with: a substrate rotating mechanism which holds and rotates the substrate; and a fluid mixture supplying mechanism which generates a fluid mixture by mixing a treatment liquid and a gas, and supplies the fluid mixture onto the surface of the substrate held by the substrate rotating mechanism. The treatment liquid may be deionized water or a resist removing liquid. Examples of the foreign matter to be removed include a resist film formed on the substrate and a residue remaining on the surface of the substrate after ashing of the resist film.

### BACKGROUND OF THE INVENTION

1. Field of the Invention

The present invention relates to a foreign matter removing apparatus for removing foreign matter adhering on a surface of a substrate after the ashing of a resist film formed on the substrate or for stripping away a resist film as foreign manner from a substrate, to a substrate treating apparatus including such a foreign matter removing apparatus, and to a substrate treating method for removing foreign matter from a substrate.

2. Description of Related Art

In production processes for semiconductor devices, liquid crystal display devices and the like, substrates such as semiconductor wafers and glass substrates are subjected to various processes such as a cleaning process, a resist application process, a photo-exposure process, a development process, an etching process, an ion implantation process, a resist removal process, an inter-level insulation film formation process and a heat treatment process.

An example of the resist removal process out of the aforesaid processes is a plasma ashing process (hereinafter referred to simply as “ashing process”) in which a resist on a substrate is allowed to react with a plasma gas thereby to be vaporized for removal thereof. The resist is typically an organic substance containing carbon, oxygen and hydrogen. In the ashing process, the resist of the organic substance chemically reacts with oxygen plasma thereby to be removed.

In practice, the resist often contains impurities such as heavy metals not easily vaporized, so that a residue including the impurities of the resist and a part of the resist adheres on a surface of the substrate after the ashing process. Foreign matter such as the residue adversely influences processes to be subsequently performed on the substrate. Therefore, the residue adhering on the substrate surface is generally removed by a chemical agent (see, for example, Japanese Unexamined Patent Publication (KOKAI) No. 9-45610 (1997)).

In another exemplary resist removal process, a resist removing liquid such as a mixture of sulfuric acid and a hydrogen peroxide solution is employed for the removal of the resist.

Where the residue adhering on the surface of the substrate subjected to the ashing process is removed by the chemical agent, however, the type of the chemical agent to be employed is limited depending on the type of the substrate. Further, where a film formed on the substrate is dissolved in a particular chemical agent or where a film formed on the substrate is not dissolved in a particular chemical agent but damaged by the chemical agent, the chemical agent cannot be employed for the removal of the residue. Therefore, it is difficult to satisfactorily remove the residue from any of various types of substrates.

In the resist removal process employing the resist removing liquid, particularly where a resist film having been used as a mask for implanting ions into the substrate thereby having been doped with the ions at a high concentration is to be removed with the use of the resist removing liquid, it is difficult to completely remove the resist film with limited reaction energy of the resist removing liquid.

### SUMMARY OF THE INVENTION

It is an object of the present invention to provide a foreign matter removing apparatus which is capable of satisfactorily removing foreign matter (e.g., a resist film or a residue resulting from the ashing of a resist film) from a surface of a substrate, a substrate treating apparatus including such a foreign matter removing apparatus, and a substrate treating method which ensures that foreign matter is satisfactorily removed from a surface of a substrate.

According to one aspect of the present invention, there is provided a foreign matter removing apparatus for removing foreign matter remaining on a surface of a substrate after ashing of a resist film formed on the substrate, the apparatus comprising: a substrate rotating mechanism which holds and rotates the substrate; and a fluid mixture supplying mechanism which generates a fluid mixture by mixing a treatment liquid and a gas, and supplies the fluid mixture to the surface of the substrate held by the substrate rotating mechanism.

In the foreign matter removing apparatus according to this inventive aspect, the substrate having been subjected to the resist film ashing process is held and rotated by the substrate rotating mechanism, and the fluid mixture generated by mixing the treatment liquid and the gas is supplied onto the surface of the rotating substrate by the fluid mixture supplying mechanism. Thus, the foreign matter remaining on the surface of the substrate after the ashing process can satisfactorily be removed.

With the use of the fluid mixture of the treatment liquid and the gas, the foreign matter can be removed in a shorter period of time.

The treatment liquid may be deionized water. In this case, the foreign matter remaining on the surface of the substrate after the ashing process can be removed at lower costs. Further, a substrate having no chemical resistance can be treated.

The treatment liquid may be a resist removing liquid. In this case, the foreign matter remaining on the surface of the substrate after the ashing process can effectively be removed.

The resist removing liquid may be a liquid mixture of sulfuric acid and a hydrogen peroxide solution. In this case, the foreign matter remaining on the surface of the substrate after the ashing process can effectively be removed.

The fluid mixture supplying mechanism may comprise a bifluid nozzle which spouts a fluid mixture of the resist removing liquid and the gas. In this case, the foreign matter removing apparatus preferably further comprises a liquid droplet collecting mechanism which has a suction port provided adjacent the bifluid nozzle and collects liquid droplets or a vapor resulting from the fluid mixture spouted from the bifluid nozzle by suction through the suction port. With this arrangement, the liquid droplets (mist-like minute liquid droplets) or the vapor resulting from the fluid mixture spouted from the bifluid nozzle are sucked in the vicinity of the source thereof for collection thereof. Thus, the droplets of the treatment liquid are prevented from adhering again on to the substrate and from adhering onto an interior surface of a treatment chamber and dripping on the substrate, thereby improving the quality of the substrate treatment.

According to another aspect of the present invention, there is provided a foreign matter removing apparatus for stripping away a resist film as foreign matter from a substrate, the apparatus comprising: a substrate rotating mechanism which holds and rotates the substrate; a bifluid nozzle which generates a fluid mixture by mixing a resist removing liquid and a gas, and spouts the fluid mixture toward the substrate held by the substrate rotating mechanism; and a liquid droplet collecting mechanism which has a suction port provided adjacent the bifluid nozzle, and collects liquid droplets or a vapor resulting from the fluid mixture spouted from the bifluid nozzle by suction through the suction port.

With this arrangement, the fluid mixture of the resist removing liquid and the gas can be supplied from the bifluid nozzle onto the substrate held and rotated by the substrate rotating mechanism. Thus, the resist film can satisfactorily be removed from the substrate by the synergistic effect of a chemical action of the resist removing liquid and a physical action provided by the impact of the liquid droplets in the fluid mixture.

Further, the liquid droplets or the vapor resulting from the fluid mixture can be sucked in the vicinity of the source thereof, and removed from the vicinity of the substrate. Therefore, the liquid droplets are prevented from adhering again onto the substrate surface and from adhering onto an interior surface of a treatment chamber and dripping on the substrate. Thus, the resist stripping process can advantageously be performed.

The liquid droplet collecting mechanism may comprise an exhaust hood which surrounds the bifluid nozzle with the suction port being disposed in opposed relation to the substrate held by the substrate rotating mechanism, and a suction mechanism which sucks ambient air in the exhaust hood together with the liquid droplets. With this arrangement, the liquid droplets or the vapor resulting from the fluid mixture can efficiently be collected by the exhaust hood, and sucked away.

Alternatively, the liquid droplet collecting mechanism may comprise a shield plate having a substrate opposing surface provided with the suction port to be brought into closely opposed relation to the substrate held by the substrate rotating mechanism. In this case, the bifluid nozzle preferably extends through the suction port to face toward the substrate held by the substrate rotating mechanism. With this arrangement, a space defined between an outlet port of the bifluid nozzle and the substrate can be limited by the shield plate, whereby ambient air in the limited space can be sucked through the suction port. Thus, the liquid droplets or the vapor can efficiently be sucked away from the space between the bifluid nozzle and the substrate.

Where the substrate to be held by the substrate rotating mechanism is a round substrate, the shield plate preferably has a round shape smaller than the round substrate held by the substrate rotating mechanism. With this arrangement, the bifluid nozzle and the shield plate can be moved above the substrate held by the substrate rotating mechanism. Thus, the entire surface of the substrate can be treated with the fluid mixture spouted from the bifluid nozzle, and the liquid droplets or the vapor resulting from the fluid mixture can efficiently be sucked away.

The substrate opposing surface may be a flat surface to be brought into proximity to the substrate held by the substrate rotating mechanism. With this arrangement, the space defined between the bifluid nozzle and the shield plate can sufficiently be limited, so that the liquid droplets or the vapor can efficiently be removed from this space.

Alternatively, the substrate opposing surface may be a concave surface which is concaved away from the substrate held by the substrate rotating mechanism. With this arrangement, the liquid droplets or the vapor can be collected by the concave substrate opposing surface thereby to be efficiently be sucked away.

The shield plate preferably has an inert gas supply port provided in a peripheral portion of the shield plate for supplying an inert gas onto the substrate held by the substrate rotating mechanism. In this case, the foreign matter removing apparatus may further comprise an inert gas supplying mechanism which supplies the inert gas into the inert gas supply port. With this arrangement, the liquid droplets or the vapor resulting from the fluid mixture can be confined in the space defined between the shield plate and the substrate, whereby the re-adhesion of the resist removing liquid onto the substrate and the growth of the droplets of the resist removing liquid on the interior surface of the treatment chamber can more effectively be suppressed.

The inert gas supplying mechanism preferably supplies a hot inert gas into the inert gas supply port. With this arrangement, temperature drop of the resist removing liquid can be suppressed. This makes it possible to maintain the activity of the resist removing liquid while efficiently collecting the liquid droplets or the vapor. Particularly where the resist removing liquid is a liquid mixture of sulfuric acid and a hydrogen peroxide solution, the resist removing liquid can be kept at a high temperature by utilizing a reaction heat generated when the sulfuric acid and the hydrogen peroxide solution are mixed. Thus, the resist stripping process can efficiently be performed. In this case, the use of the hot inert gas makes it possible to prevent the temperature drop of the resist removing liquid thereby to effectively perform the resist stripping process.

The foreign matter removing apparatus may further comprise a treatment liquid mixing mechanism which mixes the sulfuric acid and the hydrogen peroxide solution, and a stirring mechanism which stirs a mixture of the sulfuric acid and the hydrogen peroxide solution provided by the treatment liquid mixing mechanism, wherein the mixture of the sulfuric acid and the hydrogen peroxide solution stirred by the stirring mechanism is supplied as the resist removing liquid into the bifluid nozzle. With this arrangement, the sulfuric acid and the hydrogen peroxide solution are mixed by the treatment liquid mixing mechanism and then stirred by the stirring mechanism. Therefore, a mixing reaction is allowed to sufficiently proceed, so that a highly oxidative resist removing liquid can be supplied onto the substrate. Thus, the resist stripping process can advantageously be performed.

The stirring mechanism is preferably disposed as close as possible to the substrate held by the substrate rotating mechanism. Specifically, the stirring mechanism is preferably disposed in the treatment chamber in which the substrate rotating mechanism is disposed. More specifically, the stirring mechanism is preferably disposed in a resist removing liquid supply pipe in the treatment chamber.

The gas to be supplied to the bifluid nozzle is preferably a gas heated at a temperature higher than a room temperature. With this arrangement, the fluid mixture of the gas and the resist removing liquid can be generated without removing the reaction heat generated when the sulfuric acid and the hydrogen peroxide solution are mixed to provide the resist removing liquid. Thus, the resist stripping process can more efficiently be performed.

The fluid mixture supplying mechanism may include a bifluid nozzle of an external mixing type, which comprises a treatment liquid flow channel through which the treatment liquid flows, a gas flow channel through which the gas flows, a treatment liquid outlet port having an opening in communication with the treatment liquid flow channel, and a gas outlet port provided adjacent the treatment liquid outlet port and having an opening in communication with the gas flow channel.

In this case, the treatment liquid flows through the treatment liquid flow channel to be spouted from the treatment liquid outlet port, and the gas flows through the gas flow channel to be ejected from the gas outlet port, whereby the treatment liquid and the gas are mixed outside the nozzle. Thus, a mist-like fluid mixture containing minute droplets of the treatment liquid is generated. By supplying the mist-like fluid mixture onto the surface of the substrate, the foreign matter is effectively removed from the substrate surface.

The fluid mixture supplying mechanism may include a bifluid nozzle of an internal mixing type, which comprises a treatment liquid flow channel through which the treatment liquid flows, a gas flow channel through which the gas flows, a mixing chamber provided in communication with the treatment liquid flow channel and the gas flow channel for generating the fluid mixture, and a fluid mixture outlet port having an opening in communication with the mixing chamber for spouting the fluid mixture.

In this case, the treatment liquid and the gas respectively flow through the treatment liquid flow channel and the gas flow channel, and are mixed in the mixing chamber in the nozzle. The fluid mixture is spouted from the fluid mixture outlet port communicating with the mixing chamber, whereby a mist-like fluid mixture containing minute droplets of the treatment liquid is generated and supplied onto the surface of the substrate. Thus, the foreign matter is effectively removed from the substrate surface.

According to further another aspect of the present invention, there is provided a substrate treating apparatus, which comprises: an ashing apparatus which performs an ashing process for ashing a resist film formed on a surface of a substrate; a foreign matter removing apparatus which removes foreign matter from the surface of the substrate subjected to the ashing process by the ashing apparatus; and a transport mechanism which transports the substrate between the ashing apparatus and the foreign matter removing apparatus; the ashing apparatus, the foreign matter removing apparatus and the transport mechanism being provided integrally in the substrate treating apparatus.

Since the ashing apparatus, the foreign matter removing apparatus and the transport mechanism are provided integrally in the substrate treating apparatus according to this inventive aspect, the substrate having been subjected to the ashing process is immediately transported into the foreign matter removing apparatus by the transport mechanism. Thus, the foreign matter can be removed before sticking to the substrate surface.

Further, a transport region can be shared by the ashing apparatus and the foreign matter removing apparatus provided integrally in the substrate treating apparatus. Thus, space saving can be achieved.

According to still another aspect of the present invention, there is provided a substrate treating method, which comprises the steps of: performing an ashing process for ashing a resist film formed on a surface of a substrate; holding and rotating the substrate having been subjected to the ashing process; and generating a fluid mixture by mixing a treatment liquid and a gas and supplying the fluid mixture onto the surface of the rotating substrate.

In the substrate treating method according to this inventive aspect, the resist film formed on the substrate is ashed by the ashing apparatus. While the substrate having been subjected to the ashing process is held and rotated, the fluid mixture of the treatment liquid and the gas is supplied onto the surface of the rotating substrate. Thus, the foreign matter remaining on the substrate surface after the ashing process can satisfactorily be removed. The use of the fluid mixture of the treatment liquid and the gas makes it possible to remove the foreign matter in a shorter period of time.

According to further another aspect of the present invention, there is provided a substrate treating method for stripping away a resist film from a surface of a substrate, the method comprising the steps of: holding and rotating the substrate by means of a substrate rotating mechanism; mixing a resist removing liquid and a gas by a bifluid nozzle to generate a fluid mixture, and spouting the fluid mixture from the bifluid nozzle toward the surface of the substrate held by the substrate rotating mechanism simultaneously with the substrate rotating step; and positioning a suction port of a liquid droplet collecting mechanism in the vicinity of the bifluid nozzle, and collecting liquid droplets or a vapor resulting from the fluid mixture spouted from the bifluid nozzle through the suction port.

Since the resist removing liquid and the gas are mixed and supplied in the form of the fluid mixture to the substrate in this method, the resist film can efficiently be removed from the substrate by a synergistic effect of a chemical action of the resist removing liquid and a physical action provided by the impact of the liquid droplets in the fluid mixture. At the same time, the liquid droplets or the vapor resulting from the fluid mixture can be sucked from the suction port in the vicinity of the source thereof for collection thereof. Therefore, the liquid droplets of the resist removing liquid are prevented from adhering again onto the substrate and from growing on an interior surface of a treatment chamber and dripping onto the substrate. Thus, the substrate can advantageously be treated.

The foregoing and other objects, features and effects of the present invention will become more apparent from the following description of the preferred embodiments with reference to the attached drawings.

### BRIEF DESCRIPTION OF THE DRAWINGS

FIG. 1 is a plan view of a substrate treating apparatus according to an embodiment of the present invention;

FIG. 2 is a side view of a cleaning section of the substrate treating apparatus according to the embodiment;

FIG. 3 is a schematic diagram illustrating an arrangement for supplying a treatment liquid and nitrogen gas into a bifluid nozzle in the cleaning section of FIG. 2;

FIG. 4 is a block diagram illustrating the construction of a control system of the substrate treating apparatus of FIG. 1;

FIG. 5(a) is a vertical sectional view of an exemplary bifluid nozzle of a so-called external mixing type, and FIG. 5(b) is a vertical sectional view of an exemplary bifluid nozzle of a so-called internal mixing type;

FIG. 6 is a plan view for explaining operations of the bifluid nozzle and a cleaning nozzle by way of example;

FIG. 7 is a flow chart for explaining, by way of example, an ashing process and a residue removing process to be performed by employing the substrate treating apparatus according to the embodiment;

FIG. 8 is a simplified sectional view for explaining the construction of a foreign matter removing apparatus according to a second embodiment of the present invention;

FIG. 9 is a schematic diagram for explaining the construction of a foreign matter removing apparatus according to a third embodiment of the present invention; and

FIG. 10 is a fragmentary sectional view for explaining the construction of a variation of the third embodiment shown in FIG. 9.

### DESCRIPTION OF THE PREFERRED EMBODIMENTS

In the following explanation, a substrate is a semiconductor wafer, a glass substrate for a liquid crystal display device, a glass substrate for a PDP (plasma display panel), a glass substrate for a photo-mask, a substrate for an optical disk, or the like.

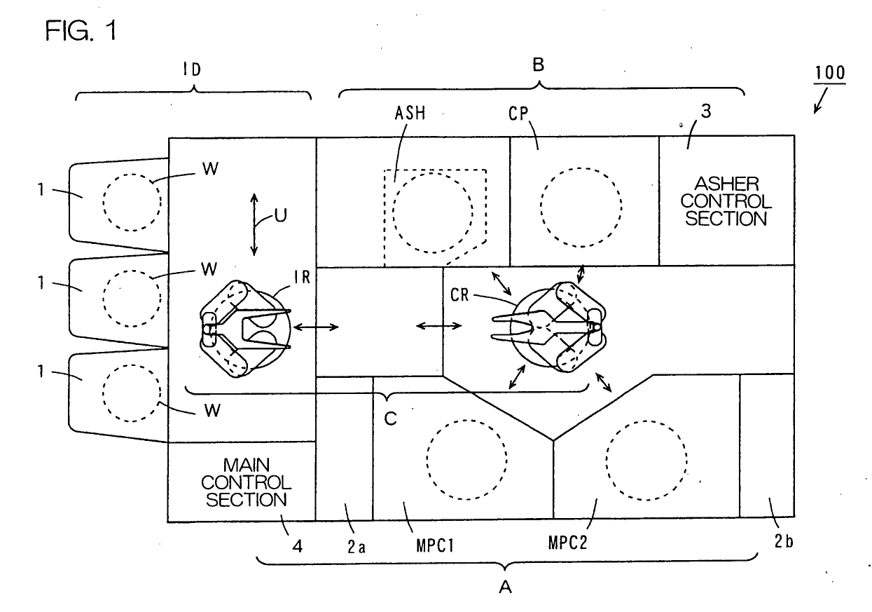

FIG. 1 is a plan view of a substrate treating apparatus according to an embodiment of the present invention. As shown in FIG. 1, the substrate treating apparatus 100 includes treatment regions A and B, and a transport region C disposed between the treatment regions A and B.

A main control section 4, fluid box sections 2a, 2b and cleaning sections MPC1, MPC2 are disposed in the treatment region A. Here, the cleaning sections MPC1, MPC2 correspond to the foreign matter removing apparatus according to the present invention.

The fluid box sections 2a, 2b accommodate fluid associated devices such as pipes, joints, valves, flow meters, regulators, pumps, temperature controllers and treatment liquid storage tanks for supplying a treatment liquid into the cleaning sections MPC1, MPC2 and for draining a waste liquid such as a used treatment liquid from the cleaning sections MPC1, MPC2.

In the cleaning sections MPC1, MPC2, a cleaning process such as a residue removing process employing a bifluid nozzle (to be described later) is performed for removing a residue including impurities and particles adhering on a surface of the substrate having been subjected to an ashing process in an ashing section ASH (to be described later), and a drying process is performed for drying the substrate having been subjected to the cleaning process.

In this embodiment, the two cleaning sections MPC1, MPC2 each having the same function are provided for improvement of the throughput of the substrate treatment. However, a single cleaning section MPC1 may be provided, if a sufficient throughput can be ensured for the substrate treatment.

The ashing section ASH, a cooling plate section CP and an asher control section 3 are provided in the treatment region B.

In the ashing section ASH, the substrate is placed on a heating plate (not shown) and, in this state, the ashing process is performed under a reduced pressure by utilizing oxygen plasma.

In the cooling plate section CP, the substrate is placed on a cooling plate (not shown), and cooled down to a predetermined temperature (e.g., 23° C.) by means of a Peltier device or by constant temperature water circulation. The cooling plate section CP is herein designed so that the substrate heated in the ashing process is cooled to a temperature at which the substrate can be subjected to the residue removing process or the cleaning process.

The ashing section ASH, the cooling plate section CP and the cleaning sections MPC1, MPC2 are each referred to generally as “treatment unit”. A substrate transport robot CR is provided in the transport region C.

An indexer ID for loading and unloading the substrate is disposed on one side of the treatment regions A, B. Carriers 1 for accommodating substrates Ware placed on the indexer ID. In this embodiment, an FOUP (front opening unified pod) which sealably accommodates a substrate W is employed as the carrier 1, but not limitative. Alternatively, an SMIF (standard mechanical interface) pod or an OC (open cassette) may be employed as the carrier 1.

An indexer robot IR of the indexer ID is adapted to move in an arrow direction U, to take a substrate W out of the carrier 1 to transfer the substrate W to the substrate transport robot CR and, conversely, to receive a substrate W subjected to a series of processes from the substrate transport robot CR to return the substrate W to the carrier 1.

The substrate transport robot CR is adapted to transport a substrate W received from the indexer robot IR to a specified treatment unit, or to transport a substrate W received from one treatment unit to another treatment unit or to the indexer robot IR.

The asher control section 3 comprises a computer including a CPU (central processing unit), and is adapted to control the operations of the ashing section ASH and the cooling plate section CP in the treatment region B. The main control section 4 comprises a computer including a CPU (central processing unit), and is adapted to control the operations of the respective units in the treatment regions A, B, the operation of the substrate transport robot CR in the transport region C, and the operation of the indexer robot IR of the indexer ID.

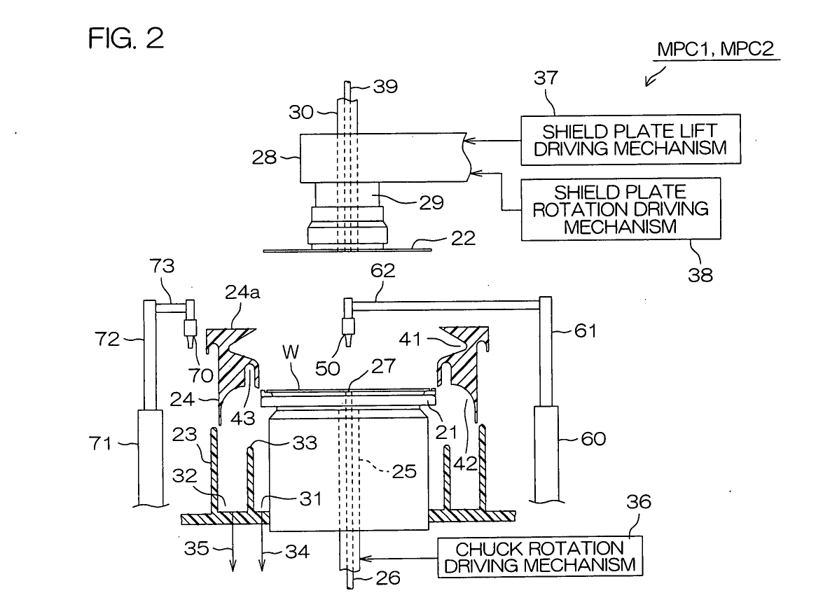

FIG. 2 is a side view of the cleaning section MPC1, MPC2 according to this embodiment.

The cleaning section MPC1, MPC2 shown in FIG. 2 is adapted to perform the residue removing process for removing the residue adhering on the surface of the substrate W with the use of a treatment liquid such as deionized water or a chemical agent after the ashing process, and to perform the drying process for drying the substrate W after the cleaning process.

As shown in FIG. 2, the cleaning section MPC1, MPC2 includes a spin chuck 21 which horizontally holds the substrate W and rotates the substrate W about a vertical rotation axis extending through the center of the substrate W. The spin chuck 21 is fixed to an upper end of a rotation shaft 25 to be rotated by a chuck rotation driving mechanism 36. Where the residue removing process is performed on the substrate W after the ashing process or the drying process is performed on the substrate W after the cleaning process, the substrate W is horizontally held and rotated by the spin chuck 21.

A first pivot motor 60 is provided outside the spin chuck 21. A first pivot shaft 61 is connected to the first pivot motor 60. A first arm 62 is connected to the first pivot shaft 61 as extending horizontally, and a bifluid nozzle 50 is provided at a distal end of the first arm 62.

The bifluid nozzle 50 is adapted to spout a fluid mixture (to be described later) for removing the residue adhering on the surface of the substrate W after the ashing process, or a treatment liquid such as deionized water or a chemical agent for cleaning the substrate W. The construction and operation of the bifluid nozzle 50 will be described later in detail.

A second pivot motor 71 is provided outside the spin chuck 21. A second pivot shaft 72 is connected to the second pivot motor 71, and a second arm 73 is connected to the second pivot shaft 72. A cleaning nozzle 70 is provided at a distal end of the second arm 73. In this embodiment, the cleaning nozzle 70 is adapted to spout a treatment liquid such as deionized water or a chemical agent for cleaning the substrate W.

When the residue is removed from the surface of the substrate W with the use of the bifluid nozzle 50 after the ashing process, the cleaning nozzle 70 is retracted to a predetermined position.

The rotation shaft 25 for the spin chuck 21 is a hollow shaft. A treatment liquid supply pipe 26 is inserted in the rotation shaft 25. A treatment liquid such as deionized water or a chemical agent (etching liquid) is supplied into the treatment liquid supply pipe 26. The treatment liquid supply pipe 26 extends to the vicinity of a lower surface of the substrate W held by the spin chuck 21. A lower surface nozzle 27 which spouts the treatment liquid toward the center of the lower surface of the substrate W is provided at a distal end of the treatment liquid supply pipe 26.

The spin chuck 21 is accommodated in a treatment cup 23. A cylindrical separation wall 33 is provided in the treatment cup 23. A liquid drain space 31 for draining the treatment liquid used for the treatment of the substrate W is provided around the spin chuck 21. Further, a liquid collection space 32 for collecting the treatment liquid used for the treatment of the substrate W is defined between the treatment cup 23 and the separation wall 33 around the liquid drain space 31.

A liquid drain pipe 34 for introducing the treatment liquid into a waste liquid treatment device (not shown) is connected to the liquid drain space 31. A collection pipe 35 for introducing the treatment liquid into a recovery device (not shown) is connected to the liquid collection space 32.

A guard 24 for preventing the treatment liquid from splashing outside the substrate W is provided above the treatment cup 23. The guard 24 is generally shaped rotationally symmetrically about the rotation shaft 25. The guard 24 has an annular liquid drain guide groove 41 formed in an upper interior surface portion thereof as having a V-shaped cross section.

The guard 24 further has a liquid collection guide portion 42 provided in a lower interior surface portion thereof as inclined outwardly downward. The liquid collection guide portion 42 has a separation wall accommodating groove 43 provided adjacent an upper edge thereof for receiving the separation wall 33 of the treatment cup 23.

The guard 24 is provided with a guard lift driving mechanism (not shown) including a ball thread mechanism. The guard lift driving mechanism is adapted to move the guard 24 between a collection position at which the liquid collection guide portion 42 is opposed to an outer peripheral surface of the substrate W held by the spin chuck 21 and a liquid drain position at which the liquid drain guide groove 41 is opposed to the outer peripheral surface of the substrate W held by the spin chuck 21. Where the guard 24 is located at the collection position (as shown in FIG. 2), the treatment liquid splashed outside the substrate W is guided into the liquid collection space 32 by the liquid collection guide portion 42, and then collected through the collection pipe 35. Where the guard 24 is located at the liquid drain position, the treatment liquid splashed outside the substrate W is guided into the liquid drain space 31 through the liquid drain guide groove 41, and then drained through the drain pipe 34. With this arrangement, the treatment liquid can properly be drained and collected.

When the substrate W is loaded onto the spin chuck 21, the guard lift driving mechanism retracts the guard 24 to a position lower than the liquid drain position so as to locate an upper edge 24a of the guard 24 at a position lower than a height at which the substrate W is held by the spin chuck 21.

A disk-shaped shield plate 22 having a center opening is disposed above the spin chuck 21. A support shaft 29 extends vertically downward from a distal end portion of an arm 28, and the shield plate 22 is attached to a lower end of the support shaft 29 in opposed relation to an upper surface of the substrate W held by the spin chuck 21.

A nitrogen gas supply channel 30 communicating with the opening of the shield plate 22 is inserted in the support shaft 29. Nitrogen gas (N₂) is supplied to the nitrogen gas supply channel 30. When the drying process is performed on the substrate W after the substrate cleaning process, the nitrogen gas is supplied onto the substrate W through the nitrogen gas supply channel 30.

Where the material for the substrate W (e.g., silicon (Si)) has a hydrophobic property, the surface of the substrate W is liable to be unevenly dried, resulting in stains or water marks on the surface of the substrate W after the drying process. The nitrogen gas is supplied to a gap defined between the substrate W and the shield plate 22 located close to each other when the drying process is performed on the substrate W after the cleaning process. Thus, the water marks on the surface of the substrate W are prevented.

A treatment liquid supply pipe 39 communicating with the opening of the shield plate 22 is inserted in the nitrogen gas supply channel 30. A rinse liquid such as deionized water is supplied into the treatment liquid supply pipe 39. The treatment liquid remaining on the surface of the substrate W after the cleaning process is rinsed away by supplying the rinse liquid onto the surface of the substrate W through the treatment liquid supply pipe 39. Other examples of the rinse liquid include organic solvents such as isopropyl alcohol (IPA), ozone water obtained by dissolving ozone in deionized water, and hydrogen water obtained by dissolving hydrogen in deionized water.

The arm 28 is connected to a shield plate lift driving mechanism 37 and a shield plate rotation driving mechanism 38. The shield plate lift driving mechanism 37 is adapted to move the shield plate 22 up and down between a position close to the upper surface of the substrate W held by the spin chuck 21 and a position upwardly far apart from the spin chuck 21.

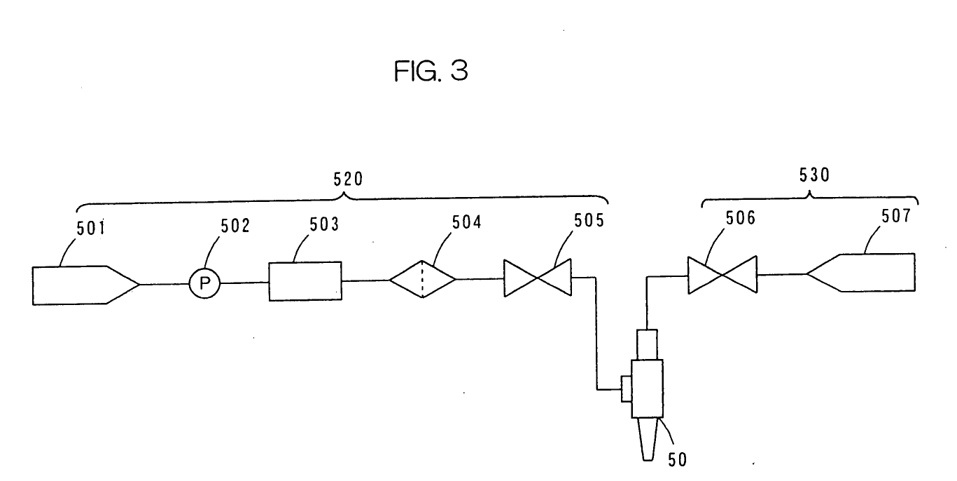

FIG. 3 is a schematic diagram illustrating an arrangement for supplying the treatment liquid and the nitrogen gas into the bifluid nozzle 50 in the cleaning section MPC1, MPC2 shown in FIG. 2.

As shown in FIG. 3, a treatment liquid supply system 520 for supplying the treatment liquid and a nitrogen gas supply system 530 for supplying nitrogen gas are connected to the bifluid nozzle 50. In this embodiment, deionized water is employed as the treatment liquid.

The treatment liquid supply system 520 includes a treatment liquid source 501, a pump 502, a temperature controller 503, a filter 504 and a first outlet valve 505. In this embodiment, the treatment liquid source 501 corresponds to a deionized water storage tank or a deionized water utility generally provided in a semiconductor product manufacturing plant.

The treatment liquid is pumped from the treatment liquid source 501 by the pump 502, and heated or cooled at a predetermined temperature by the temperature controller 503. Thus, the temperature of the treatment liquid is controlled at the predetermined temperature (e.g., at a room temperature on the order of 22 to 25° C.). Thereafter, the temperature-controlled treatment liquid is passed through the filter 504, whereby contaminants are removed from the treatment liquid. Then, the treatment liquid is supplied into the bifluid nozzle 50 through the first outlet valve 505.

The nitrogen gas supply system 530 includes a second outlet valve 506 and a nitrogen gas source 507. Nitrogen gas is supplied from the nitrogen gas source 507 to the bifluid nozzle 50 through the second outlet valve 506 under pressure. In this embodiment, the nitrogen gas source 507 is a nitrogen gas cylinder or a nitrogen gas utility generally provided in the semiconductor product manufacturing plant.

An arrangement for supplying the treatment liquid into the cleaning nozzle 70 for the cleaning has substantially the same construction as the treatment liquid supply system 520.

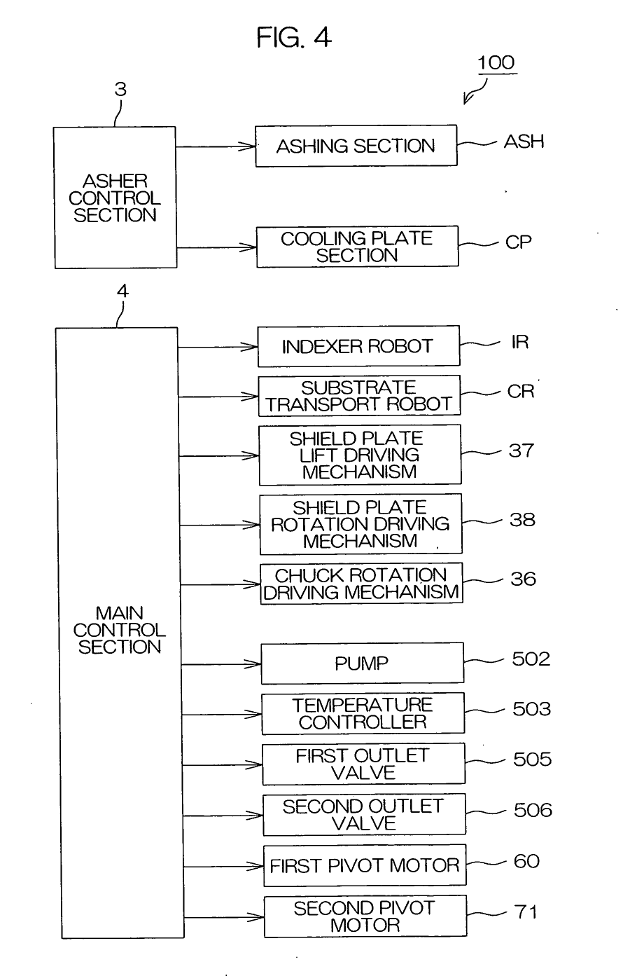

FIG. 4 is a block diagram illustrating the construction of a control system of the substrate treating apparatus of FIG. 1. As shown in FIG. 4, the substrate treating apparatus 100 includes the asher control section 3 and the main control section 4.

The asher control section 3 controls various operations for performing the substrate ashing process in the ashing section ASH. The asher control section 3 further controls various operations for performing a cooling process on the substrate in the cooling plate section CP.

The main control section 4 controls the substrate transport operations of the indexer robot IR and the substrate transport robot CR and the operations for driving the shield plate lift driving mechanism 37, the shield plate rotation driving mechanism 38 and the chuck rotation driving mechanism 36 in the cleaning section MPC1, MPC2.

The main control section 4 further controls the pumping operation of the pump 502 and the temperature controlling operation of the temperature controller 503. The main control section 4 further controls the opening/closing operations of the first outlet valve 505 and the second outlet valve 506 and the rotative operations of the first pivot motor 60 and the second pivot motor 71 in the cleaning section MPC1, MPC2.

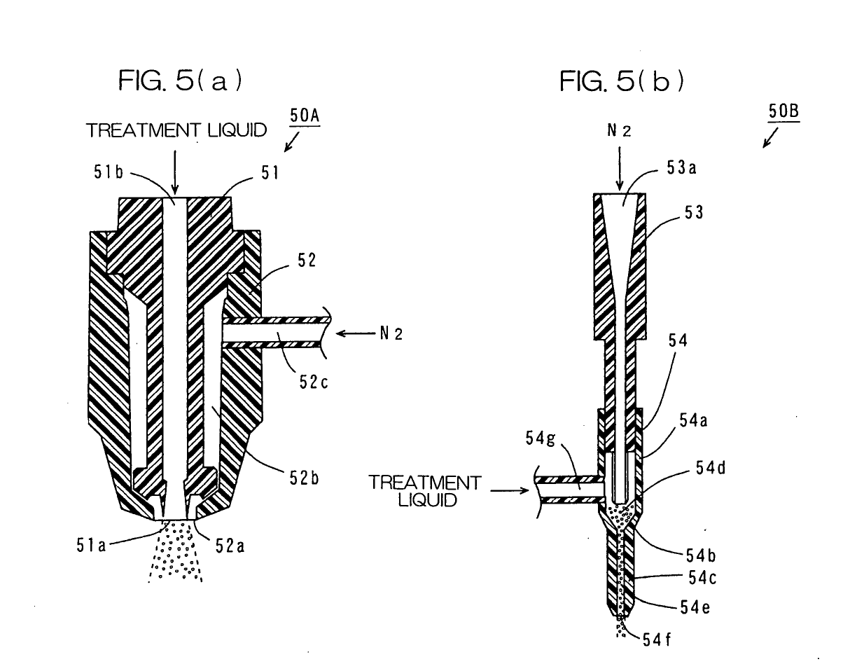

The construction of the bifluid nozzle 50 will be described with reference to FIGS. 5(a) and 5(b). FIG. 5(a) is a vertical sectional view of an exemplary bifluid nozzle 50A of a so-called external mixing type, and FIG. 5(b) is a vertical sectional view of an exemplary bifluid nozzle 50B of a so-called internal mixing type. A major difference between these two bifluid nozzles is whether two fluids are mixed inside the nozzle or outside the nozzle for the generation of the fluid mixture.

The external mixing type bifluid nozzle 50A shown in FIG. 5(a) includes an inner main body 51 and an outer main body 52. The inner main body 51 is composed of, for example, quartz, while the outer main body 52 is composed of, for example, a fluorine-containing resin such as PTFE (polytetrafluoroethylene).

The inner main body 51 has a treatment liquid introduction portion 51b extending along a center line thereof. The inner main body 51 further has a treatment liquid outlet port 51a provided at a lower end thereof in communication with the treatment liquid introduction portion 51b. The inner main body 51 is inserted in the outer main body 52. The inner main body 51 and the outer main body 52 are connected to each other at upper ends thereof, but not connected to each other at lower ends thereof.

An annular gas passage 52b is defined between the inner main body 51 and the outer main body 52. The outer main body 52 has a gas outlet port 52a provided at a lower end thereof in communication with the gas passage 52b. A gas introduction portion 52c is provided in a peripheral wall of the outer main body 52 in communication with the gas passage 52b.

The diameter of a portion of the gas passage 52b adjacent to the gas outlet port 52a is reduced toward the lower end. As a result, the nitrogen gas is ejected from the gas outlet port 52a at an increased flow rate.

With the external mixing type bifluid nozzle 50A of FIG. 5(a), the treatment liquid spouted from the treatment liquid outlet port 51a is mixed with the nitrogen gas ejected from the gas outlet port 52a in the vicinity of the lower end of the bifluid nozzle 50A outside the bifluid nozzle 50A, whereby a mist-like fluid mixture containing minute droplets of the treatment liquid is generated. The residue adhering on the surface of the substrate W subjected to the ashing process is effectively removed by spouting the mist-like fluid mixture onto the surface of the substrate W.

In this case, the mist-like fluid mixture is generated after the treatment liquid and the nitrogen gas are ejected from the treatment liquid outlet port 51a and the gas outlet port 52a, respectively. Therefore, the flow amounts and flow rates of the treatment liquid and the nitrogen gas are independently maintained in the treatment liquid outlet port 51a and the gas outlet port 52a, respectively. Thus, the fluid mixture can be provided as desired by controlling the flow amounts and flow rates of the treatment liquid and the nitrogen gas at desired levels. For example, the impact or shock of the fluid mixture on the substrate W can be reduced by controlling the flow amount of the nitrogen gas.

The internal mixing type bifluid nozzle SOB shown in FIG. 5(b) includes a gas inlet pipe 53 and a main body 54. The main body 54 is composed of, for example, quartz, and the gas inlet pipe 53 is composed of, for example, PTFE.

The gas inlet pipe 53 has a gas introduction portion 53a extending from an upper end to a lower end thereof. The main body 54 includes an upper cylinder 54a having a greater diameter, a taper portion 54b and a lower cylinder 54c having a smaller diameter.

A mixing chamber 54d is defined in the taper portion 54b, and a straight flow portion 54e is defined in the lower cylinder 54c. The lower cylinder 54c has a fluid mixture outlet port 54f provided at a lower end thereof in communication with the straight flow portion 54e.

The upper cylinder 54a of the main body 54 is provided with a treatment liquid introduction portion 54g which communicates with the mixing chamber 54d. A lower end portion of the gas inlet pipe 53 is inserted in the mixing chamber 54d in the upper cylinder 54a of the main body 54.

With the interior mixing type bifluid nozzle SOB of FIG. 5(b), the nitrogen gas is supplied from the gas introduction portion 53a under pressure, and the treatment liquid is supplied from the treatment liquid introduction portion 54g. Thus, the treatment liquid is mixed with the nitrogen gas in the mixing chamber 54d, whereby a mist-like fluid mixture containing minute droplets of the treatment liquid is generated.

The fluid mixture generated in the mixing chamber 54d passes along the taper portion 54b through the straight flow portion 54e thereby to be accelerated. The accelerated fluid mixture is spouted from the fluid mixture outlet port 54f thereby to be supplied onto the surface of the substrate W. Thus, the residue adhering on the surface of the substrate W subjected to the ashing process is effectively removed.

With the internal mixing type bifluid nozzle 50B of FIG. 5(b), the impact or shock of the fluid mixture on the substrate W can be reduced, for example, by controlling the flow amount of the nitrogen gas.

The external mixing type bifluid nozzle 50A of FIG. 5(a) and the internal mixing type bifluid nozzle SOB of FIG. 5(b) are selectively employed depending on the application.

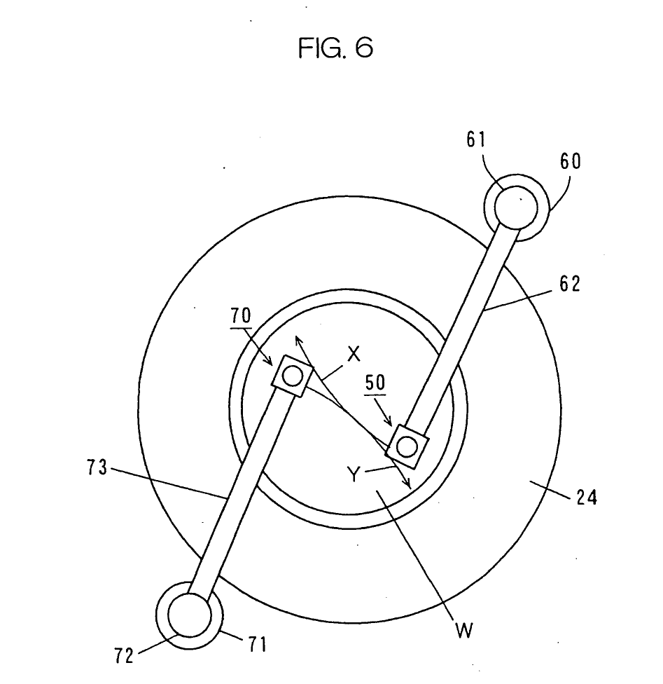

FIG. 6 is a plan view for explaining the operations of the bifluid nozzle 50 and the cleaning nozzle 70 by way of example.

When the first pivot shaft 61 is pivoted by the first pivot motor 60, the first arm 62 is swung within a horizontal plane as shown in FIG. 6. Thus, the bifluid nozzle 50 provided at the distal end of the first arm 62 is moved above the substrate W. In this case, the bifluid nozzle 50 are reciprocally moved along an arc X extending between opposite points on the peripheral edge of the substrate W through the rotation center of the substrate W for a predetermined period of time.

In this embodiment, the bifluid nozzle 50 may be the external mixing type bifluid nozzle 50A or the internal mixing type bifluid nozzle SOB. However, where it is desired to suppress a damage to a film formed on the substrate W, the external mixing type bifluid nozzle 50A is more preferable which is capable of generating liquid droplets having smaller diameters and controlling the pressure and the flow amount within wider ranges.

When the second pivot shaft 72 is pivoted by the second pivot motor 71, the second arm 73 is swung within a horizontal plane. Thus, the cleaning nozzle 70 provided at the distal end of the second arm 73 is moved above the substrate W. In this case, the cleaning nozzle 70 is reciprocally moved along an arc Y between opposite points on the peripheral edge of the substrate W through the rotation center of the substrate W for a predetermined period of time. The bifluid nozzle 50 may reciprocally be moved between the rotation center of the substrate W and one of the opposite points on the peripheral edge of the substrate W, and the cleaning nozzle 70 may reciprocally be moved between the rotation center of the substrate W and one of the opposite points on the peripheral edge of the substrate W.

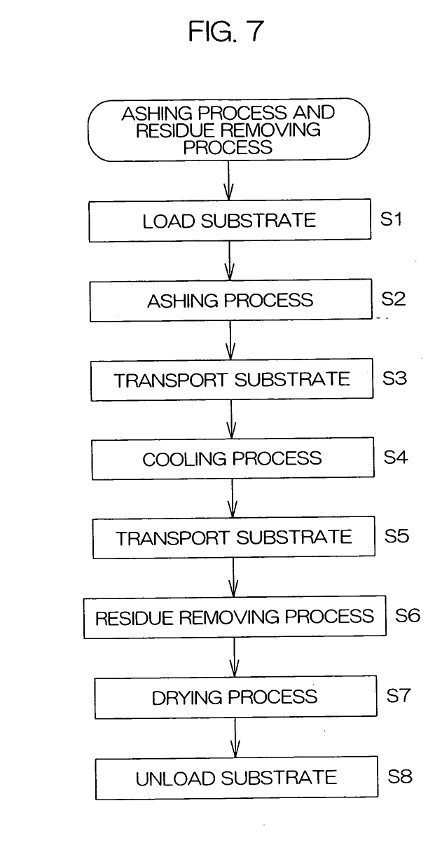

FIG. 7 is a flow chart for explaining, by way of example, the ashing process and the residue removing process by the bifluid nozzle in the substrate treating apparatus according to this embodiment.

As shown in FIG. 7, a substrate W is transported into the ashing section ASH by the substrate transport robot CR (Step S1). Then, the ashing process is performed on the substrate W in the ashing section ASH (Step S2).

In turn, the substrate W is transported by the substrate transport robot CR (Step S3). In this case, the substrate W having been subjected to the ashing process is transported out of the ashing section ASH into the cooling plate section CP by the substrate transport robot CR.

Subsequently, the cooling process is performed on the substrate W in the cooling plate section CP (Step S4). In this case, the substrate W heated in the ashing process is cooled to a room temperature by a cooling plate (not shown).

Then, the substrate W is transported by the substrate transport robot CR (Step S5). In this case, the substrate W thus cooled is transported out of the cooling plate section CP into one of the cleaning sections MPC1, MPC2 containing no substrate W by the substrate transport robot CR.

In turn, the residue removing process is performed on the substrate W in the cleaning section MPC1, MPC2 (Step S6). In this case, a residue adhering on a surface of the substrate W having been subjected to the ashing process is removed by the fluid mixture spouted from the bifluid nozzle 50 shown in FIG. 2.

Subsequently, the drying process is performed on the surface of the substrate W subjected to the residue removing process in the cleaning section MPC1, MPC2 (Step S7). In this case, the shield plate 22 is moved into proximity to the upper surface of the substrate W held by the spin chuck 21, and nitrogen gas is supplied to the space defined between the lower surface of the shield plate 22 and the upper surface of the substrate W from the nitrogen gas supply channel 30. At the same time, the substrate W is rotated in a horizontal attitude by the spin chuck 21, whereby liquid droplets remaining on the surface of the substrate W are spun off.

Thereafter, the substrate W is transported out of the cleaning section MPC1, MPC2 by the substrate transport robot CR (Step S8).

Before or after Step S6, the cleaning process may be performed by spouting the treatment liquid (e.g., deionized water or a chemical agent) toward the surface of the substrate W through the cleaning nozzle 70 or the treatment liquid supply pipe 39. More specifically, the substrate W transported into the cleaning section MPC1, MPC2 after the ashing process may first be treated with the chemical agent or the deionized water, and then subjected to the residue removing process (Step S6) by means of the bifluid nozzle 50 and to the drying process (Step S7). Alternatively, the substrate W may first be subjected to the residue removing process (Step S6) by means of the bifluid nozzle 50, and then treated with the chemical agent or the deionized water and subjected to the drying process (Step S7). Thus, the cleaning effect can be improved.

The steps of the ashing process and the residue removing process shown in FIG. 7 are merely illustrative but not limitative. The order of the respective processes and the number of times of repetition of the processes may be determined without substantially changing the processes.

As described above, the fluid mixture generated by the bifluid nozzle 50 is spouted onto the surface of the substrate W for removing the residue adhering on the surface of the substrate W having been subjected to the ashing process in this embodiment. Thus, the residue adhering on the surface of the substrate W having been subjected to the ashing process can effectively be removed. This makes it possible to improve the quality of the substrate W and to reduce the time required for the residue removing process.

Further, the fluid mixture of the deionized water and the nitrogen gas is employed for removing the residue adhering on the surface of the substrate W having been subjected to the ashing process without the use of the chemical agent. Therefore, the residue removing process can be performed even on a substrate W having no chemical resistance.

Since the deionized water is less expensive than the chemical agent, the costs for the process can be reduced.

Further, the ashing section ASH which performs the ashing process on the substrate W and the cleaning sections MPC1, MPC2 which remove the residue adhering on the surface of the substrate W having been subjected to the ashing process are provided integrally in the substrate treating apparatus 100. Therefore, the transport device and the transport region can be shared by the respective sections. This allows for space saving.

There is no need to accommodate the substrate W having been subjected to the ashing process in the carrier 1 when the substrate W is transported into the cleaning section. Hence, there is no possibility that the residue sticks to the surface of the substrate W during the transportation of the substrate W in the carrier 1 after the ashing process to make the removal of the residue difficult.

In this embodiment, the spin chuck 21 corresponds to the substrate rotating mechanism, and the bifluid nozzle 50 corresponds to the fluid mixture supplying mechanism. The treatment liquid introduction portions 51b, 54g correspond to the treatment liquid flow channel, and the gas passage 52b, the gas introduction portion 52c and the gas introduction portion 53a correspond to the gas flow channel. The ashing section ASH corresponds to the ashing apparatus, and the cleaning sections MPC1, MPC2 correspond to the foreign matter removing apparatus. The substrate transport robot CR corresponds to the transport mechanism.

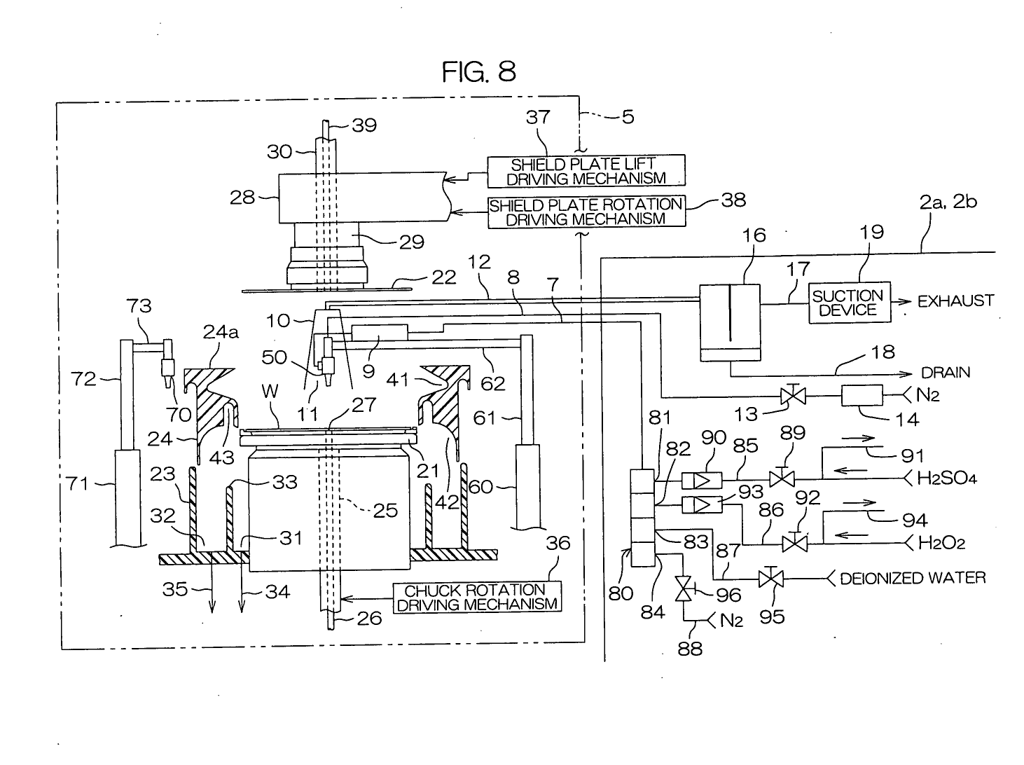

FIG. 8 is a simplified sectional view for explaining the construction of a foreign matter removing apparatus according to a second embodiment of the present invention. The foreign matter removing apparatus is employed as the cleaning section MPC1, MPC2 in the substrate treating apparatus shown in FIG. 1. In this embodiment, a resist removing liquid is employed instead of the deionized water as the treatment liquid to be supplied into the bifluid nozzle 50. In this embodiment, the resist removing liquid is a liquid mixture of sulfuric acid and a hydrogen peroxide solution.

More specifically, the resist removing liquid is supplied into the bifluid nozzle 50 from a fluid box section 2a, 2b disposed adjacent a treatment chamber 5 through a treatment liquid pipe 7, and nitrogen gas as an exemplary inert gas is supplied into the bifluid nozzle 50 through a nitrogen gas pipe 8. In the treatment chamber 5, a stirring fin communication pipe 9 is provided in the treatment liquid pipe 7. The stirring fin communication pipe 9 is adapted to stir the liquid mixture of sulfuric acid and the hydrogen peroxide solution for promotion of the mixing, thereby providing a highly oxidative resist removing liquid. The stirring fin communication pipe 9 is attached to the arm 62 so as to be disposed as close as possible to the bifluid nozzle 50.

The bifluid nozzle 50 is attached to the distal end portion of the arm 62, and an exhaust hood 10 is fixed to the distal end portion of the arm 62 as surrounding the bifluid nozzle 50 in opposed relation to an upper surface of a substrate W held by the spin chuck 21. The exhaust hood 10 has a horn shape such that a suction port 11 thereof is located on a lower side thereof in opposed relation to the upper surface of the substrate W held by the spin chuck 21. The outlet of the bifluid nozzle 50 is located generally centrally of the suction port 11. The horn-shaped exhaust hood 10 is flared downward toward the substrate W held by the spin chuck 21, so that liquid droplets (mist-like minute liquid droplets) and a vapor resulting from the fluid mixture spouted from the bifluid nozzle 50 can be collected by the exhaust hood 10. An exhaust pipe 12 is connected to the exhaust hood 10, and further connected to the fluid box section 2a, 2b.

The treatment liquid pipe 7 is a tube composed of, for example, a PFA (perfluoroalkylvinyl ether-tetrafluoroethylene copolymer) excellent in chemical resistance and heat resistance. The treatment liquid pipe 7 extends outside the treatment chamber 5, and is connected to a mixing valve 80 disposed in the fluid box section 2a, 2b.

The mixing valve 81 has four inlet ports, i.e., a sulfuric acid port 81, a hydrogen peroxide solution port 82, a deionized water port 83 and a nitrogen gas port 84. A sulfuric acid pipe 85 for supplying temperature-controlled sulfuric acid (e.g., at 80° C.) from a sulfuric acid supply source is connected to the sulfuric acid port 81, and a hydrogen peroxide solution pipe 86 for supplying the hydrogen peroxide solution from a hydrogen peroxide solution supply source is connected to the hydrogen peroxide solution port 82. A deionized water pipe 87 for supplying the deionized water from a deionized water supply source is connected to the deionized water port 83. Further, a nitrogen gas pipe 88 for supplying the nitrogen gas from a nitrogen gas supply source is connected to the nitrogen gas port 84.

A sulfuric acid valve 89 for turning on and off the supply of the sulfuric acid to the mixing valve 80 and a sulfuric acid flow amount meter 90 for detecting the flow amount of the sulfuric acid flowing through the sulfuric acid pipe 85 are provided in this order from an upstream side in the midst of the sulfuric acid pipe 85. Further, a sulfuric acid feed-back channel 91 is branched from the sulfuric acid pipe 85 at a branch point upstream of the sulfuric acid valve 89. When the sulfuric acid valve 89 is closed, the sulfuric acid flowing through the sulfuric acid pipe 85 is fed back into the sulfuric acid supply source through the sulfuric acid feed-back channel 91. With the sulfuric acid valve 89 being closed, the sulfuric acid is circulated in a sulfuric acid circulation channel constituted by the sulfuric acid supply source, the sulfuric acid pipe 85 and the sulfuric acid feed-back channel 91, while being temperature-controlled at the predetermined temperature by a temperature controller (not shown) provided in the sulfuric acid circulation channel. Thus, the sulfuric acid does not stagnate in a portion of the sulfuric acid pipe 85 downstream of the sulfuric acid valve 89. Therefore, the sulfuric acid temperature-controlled at the predetermined temperature can be supplied to the mixing valve 80 immediately after the sulfuric acid valve 89 is opened.

A hydrogen peroxide solution valve 92 for turning on and off the supply of the hydrogen peroxide solution to the mixing valve 80 and a hydrogen peroxide solution flow amount meter 93 for detecting the flow amount of the hydrogen peroxide solution flowing through the hydrogen peroxide solution pipe 86 are provided in this order from an upstream side in the midst of the hydrogen peroxide solution pipe 86. Further, a hydrogen peroxide solution feed-back channel 94 is branched from the hydrogen peroxide solution pipe 86 at a branch point upstream of the hydrogen peroxide solution valve 92. When the hydrogen peroxide solution valve 92 is closed, the hydrogen peroxide solution flowing through the hydrogen peroxide solution pipe 86 is fed back into the hydrogen peroxide solution supply source through the hydrogen peroxide solution feed-back channel 94. With the hydrogen peroxide solution valve 92 being closed, the hydrogen peroxide solution is circulated in a hydrogen peroxide solution circulation channel constituted by the hydrogen peroxide solution supply source, the hydrogen peroxide solution pipe 86 and the hydrogen peroxide solution feed-back channel 94 so as not to stagnate in a portion of the hydrogen peroxide solution pipe 86 downstream of the hydrogen peroxide solution valve 92. In this embodiment, the hydrogen peroxide solution is not temperature-controlled, and flows through the hydrogen peroxide solution pipe 86 at a room temperature (about 25° C.).

A deionized water valve 95 for turning on and off the supply of the deionized water to the mixing valve 80 is provided in the midst of the deionized water pipe 87.

A nitrogen gas valve 96 for turning on and off the supply of the nitrogen gas to the mixing valve 80 is provided in the midst of the nitrogen gas pipe 88. When the supply of the resist removing liquid to the substrate W is stopped, the valves 89, 92 are closed, and then the nitrogen gas valve 96 is kept open for a predetermined period of time. Thus, the liquid mixture of the sulfuric acid and the hydrogen peroxide solution remaining in a channel extending between the mixing valve 80 and the outlet port of the bifluid nozzle 50 is completely discharged from the bifluid nozzle 50 onto the substrate W.

When the sulfuric acid port 81 and the hydrogen peroxide solution port 82 of the mixing valve 80 are opened with the sulfuric acid valve 89 and the hydrogen peroxide solution valve 92 being open, the sulfuric acid and the hydrogen peroxide solution flow into the mixing valve 80 from the sulfuric acid pipe 85 and the hydrogen peroxide solution pipe 86, respectively, and join in the mixing valve 80 to provide the liquid mixture of the sulfuric acid and the hydrogen peroxide solution. The liquid mixture of the sulfuric acid and the hydrogen peroxide solution flows out of the mixing valve 80 into the treatment liquid pipe 7, and is introduced into the bifluid nozzle 50 through the treatment liquid pipe 7.

In the mixing valve 80, the sulfuric acid and the hydrogen peroxide solution respectively supplied from the sulfuric acid pipe 85 and the hydrogen peroxide solution pipe 86 are simply joined together. Hence, the liquid mixture flowing out of the mixing valve 80 into the treatment liquid pipe 7 does not serve as the resist removing liquid (SPM: sulfuric acid/hydrogen peroxide mixture) in which the sulfuric acid and the hydrogen peroxide solution are homogeneously mixed. Therefore, the aforesaid stirring fin communication pipe 9 is provided in the treatment liquid pipe 7 for stirring the liquid mixture of the sulfuric acid and the hydrogen peroxide solution flowing through the treatment liquid pipe 7 to provide the homogenous SPM liquid.

The stirring fin communication pipe 9 includes a pipe member and a plurality of stirring fins each comprising a rectangular plate twisted about a liquid flow axis by about 180 degrees and disposed in the pipe member in 90-degree offset relation about a center axis of the pipe extending along the fluid flow axis. For example, an inline mixer available under the trade name of MX-series INLINE MIXER from Noritake Company Limited, Advance Electric Company. The liquid mixture of the sulfuric acid and the hydrogen peroxide solution is sufficiently stirred in the stirring fin communication pipe 9, whereby a chemical reaction between the sulfuric acid and the hydrogen peroxide solution (H₂SO₄+H₂O₂→H₂SO₅+H₂O) occurs to provide the SPM liquid containing highly oxidative H₂SO₅. At this time, heat (reaction heat) is generated by the chemical reaction, so that the temperature of the SPM liquid is assuredly raised to a high temperature (e.g., 80° C. to 150 C) at which a resist film formed on the surface of the substrate W can properly be stripped away. The resist removing liquid of the hot SPM liquid generated in the stirring fin communication pipe 9 is mixed with the nitrogen gas in the bifluid nozzle 50 to provide the fluid mixture, which is supplied onto the substrate W.

The nitrogen gas pipe 8 extends into the fluid box section 2a, 2b, and a nitrogen gas valve 13 and a temperature controller 14 are provided in a portion of the nitrogen gas pipe 8 downstream of the nitrogen gas supply source within the fluid box section 2a, 2b. The temperature controller 14 includes, for example, a heater which heats the nitrogen gas flowing through the nitrogen gas pipe 8 to provide hot nitrogen gas (e.g., at 100° C. to 150C) By introducing the hot nitrogen gas into the bifluid nozzle 50 through the nitrogen gas pipe 8, the fluid mixture of the SMP liquid and the nitrogen gas is generated in the bifluid nozzle 50 without removing heat from the resist removing liquid of the SPM liquid. Therefore, liquid droplets in the fluid mixture are caused to impinge on the surface of the substrate W at a high temperature.

The exhaust pipe 12 connected to the exhaust hood 10 is connected to the fluid box section 2a, 2b. In the fluid box section 2a, 2b, the exhaust pipe 12 is connected to a gas-liquid separator 16 for separating the gas and the liquid from each other. The gas and the liquid separated by the gas-liquid separator 16 are introduced into an exhaust pipe 17 and a drain pipe 18, respectively. The exhaust pipe 17 is connected to a suction device 19.

With this arrangement, ambient air present in the vicinity of a fluid mixture supplying spot on the upper surface of the substrate W to which the droplets of the resist removing liquid are supplied from the bifluid nozzle 50 is sucked through the suction port 11 of the exhaust hood 10 attached to the arm 62.

The resist removing liquid of the SPM liquid is spouted from the bifluid nozzle 50 at a high temperature on the order of 150° C. due to the reaction heat generated by the mixing of the sulfuric acid and the hydrogen peroxide solution. Therefore, a vapor is generated from the hot resist removing liquid. Further, mist-like minute liquid droplets spread in the ambient air present in the vicinity of the bifluid nozzle 50. The vapor and droplets of the resist removing liquid can be sucked away together with the ambient air present in the vicinity of the bifluid nozzle 50 (the source of the vapor and the liquid droplets) from the vicinity of the substrate W.

The bifluid nozzle 50 and the exhaust hood 10 are supported together by the arm 62. Therefore, when the bifluid nozzle 50 is moved by pivoting the arm 62, a positional relationship between the bifluid nozzle 50 and the exhaust hood 10 is maintained so that the exhaust hood 10 follows the bifluid nozzle 50. Thus, the vapor and the liquid droplets resulting from the fluid mixture of the resist removing liquid and the nitrogen gas supplied from the bifluid nozzle 50 are assuredly sucked away from the vicinity of the substrate W. In addition, the exhaust hood 10 is directed toward the fluid mixture supplying spot on the upper surface of the substrate W to which the fluid mixture is supplied from the bifluid nozzle 50, and has a horn shape flaring toward the suction port 11 thereof which opens in the vicinity of the fluid mixture supplying spot. Thus, the vapor and the liquid droplets generated in the vicinity of the bifluid nozzle 50 can efficiently be sucked away.

Thus, the liquid droplets resulting from the fluid mixture supplied from the bifluid nozzle 50 are prevented from adhering again onto the substrate W to contaminate the substrate W. Further, the vapor and the liquid droplets are prevented from adhering onto components (e.g., the guard 24 and the arm 62) disposed adjacent the substrate W to condense and grow thereby to drip onto the substrate W. As a result, the contamination of the substrate W with particles can be prevented thereby to improve the treatment quality.

Since the re-adhesion of the vapor and droplets of the resist removing liquid on the guard 24 and the arm 62 disposed adjacent the bifluid nozzle 50 is suppressed, the cleaning of these components is less frequently required, or even obviated.

The vapor and the liquid droplets are generated from the fluid mixture supplied from the bifluid nozzle 50 mainly when the droplets of the resist removing liquid are spouted from the bifluid nozzle 50. Therefore, the suction device 19 is preferably driven under the control of the main control section 4 (see FIG. 4) at least when the sulfuric acid valve 89 and the hydrogen peroxide solution valve 92 are opened. For example, the driving of the suction device 19 may be started before the ejection of the resist removing liquid is started with the sulfuric acid valve 89 and the hydrogen peroxide solution valve 92 being open. Then, the suction device 19 may be stopped after the ejection of the resist removing liquid is stopped with these valves 89, 92 being closed. Of course, the suction device 19 may constantly be driven.

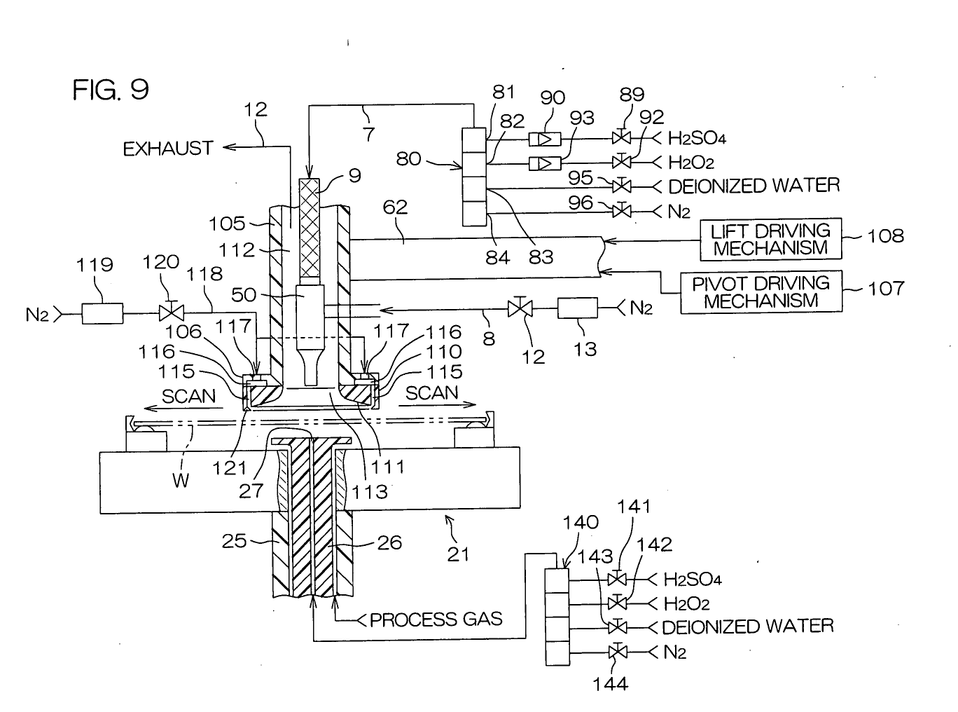

FIG. 9 is a schematic diagram for explaining the construction of a foreign matter removing apparatus according to a third embodiment of the present invention. In the substrate treating apparatus of FIG. 1, this foreign matter removing apparatus may be used instead of the cleaning section MPC1, MPC2. In FIG. 9, components corresponding to those shown in FIG. 8 will be denoted by the same reference characters as in FIG. 8.

In this embodiment, a straight exhaust pipe 105 is attached vertically to the distal end of the arm 62, and the bifluid nozzle 50 is accommodated coaxially in the exhaust pipe 105. The exhaust pipe 105 includes a flange 106 extending outward from a lower edge thereof on the side of the spin chuck 21. A disk-shaped shield plate 110 as an exhaust hood is fixed to the lower edge of the exhaust pipe 105 in alignment with the flange 106 so as to be opposed to the upper surface of the substrate W held by the spin chuck 21.

The arm 62 is adapted to be pivoted horizontally by a pivot driving mechanism 107 including the pivot motor 60 or the like, and moved up and down above the spin chuck 21 by a lift driving mechanism 108. Thus, the upper surface of the substrate W is scanned by the bifluid nozzle 50, and the shield plate 110 is moved toward and away from the upper surface of the substrate W.

The shield plate 110 has a substrate opposing surface 111 to be brought into closely opposed relation to the upper surface of the substrate W held by the spin chuck 21. The substrate opposing surface 111 has a suction port 113 provided at the center thereof in communication with an inner space 112 of the exhaust pipe 105, and is concaved upward away from the substrate W held by the spin chuck 21. Thus, the substrate opposing surface 111 has a horn shape flared toward the upper surface of the substrate W held by the spin chuck 21. The outlet of the bifluid nozzle 50 is located generally centrally of the suction port 113. An end portion (lower end portion) of the bifluid nozzle 50 on the side of the substrate W is located more distantly from the substrate W than a portion of the shield plate 110 closest to the substrate W. Therefore, the shield plate 110 is located in proximity to the upper surface of the substrate W held by the spin chuck 21 with the bifluid nozzle 50 being spaced a predetermined distance from the upper surface of the substrate W held by the spin chuck 21.

Where the substrate W is a round substrate such as a semiconductor wafer, the shield plate 110 has a disk shape having smaller diameter than the round substrate W. With this arrangement, the arm 62 is swung above the substrate W held by the spin chuck 21, and the shield plate 110 is moved together with the bifluid nozzle 50.

The shield plate 110 has a nitrogen gas supply port 115 vertically extending through a peripheral portion thereof and opening in a peripheral portion of the substrate opposing surface 111. The nitrogen gas supply port 115 may include a plurality of nitrogen gas supply ports arranged in circumferentially spaced relation in the peripheral portion of the shield plate 110, but is preferably provided as an annular slit-shaped opening circumferentially continuously extending along the peripheral portion of the substrate opposing surface 111.

The flange 106 of the exhaust pipe 105 has an annular groove 116 provided on a lower surface thereof (mated with the shield plate 110). The flange 106 has a through-hole 117 extending therethrough in communication with the annular grove 116. Nitrogen gas is supplied into the through-hole 117 from the nitrogen gas supply source through a nitrogen gas supply pipe 118. A temperature controller 119 such as a heater and a nitrogen gas valve 120 are provided in the nitrogen gas supply pipe 118. With the nitrogen gas valve 120 being open, nitrogen gas heated (e.g., at 100° C. to 150° C.) by the temperature controller 119 flows through the through-hole 117 and the annular groove 116, and then is ejected toward the substrate W through the nitrogen gas supply port 115.

An annular guide projection 121 is provided circumferentially around an outlet of the nitrogen gas supply port 115 as projecting beyond the substrate opposing surface 111 toward the spin chuck 21. The guide projection 121 guides the hot nitrogen gas ejected from the nitrogen gas supply port 115 obliquely toward the center axis of the substrate opposing surface 111.

Therefore, the nitrogen gas ejected from the nitrogen gas supply port 115 suppresses or prevents the outward spreading of the vapor or the liquid droplets resulting from the fluid mixture generated by the bifluid nozzle 50. Thus, the vapor or the liquid droplets are mostly guided into the exhaust pipe 105 from the horn-shaped substrate opposing surface 110 through the suction port 113 thereby to be removed through the exhaust pipe 12.

In this embodiment, the stirring fin communication pipe 9 is disposed coaxially with the exhaust pipe 105 within the exhaust pipe 105. Thus, the sulfuric acid and the hydrogen peroxide solution are mixed in the vicinity of the bifluid nozzle 50, so that the resist removing process can be performed on the substrate W by utilizing the reaction heat generated by the mixing.

In this embodiment, the treatment liquid is supplied from a mixing valve 140 into the treatment liquid supply pipe 26 through which the treatment liquid is supplied into the lower surface nozzle 27. The sulfuric acid (temperature-controlled, for example, at about 80° C.) from the sulfuric acid supply source is supplied into the mixing valve 140 through the sulfuric acid valve 141, and the hydrogen peroxide solution from the hydrogen peroxide solution supply source is supplied into the mixing valve 140 through the hydrogen peroxide solution valve 142. Further, the deionized water from the deionized water supply source is supplied into the mixing valve 140 through the deionized water valve 143, and the nitrogen gas (heated, for example, at 100° C. to 150° C.) from the nitrogen gas supply source is supplied into the mixing valve 140 through the nitrogen gas valve 144.

Therefore, the liquid mixture can be spouted toward the center of the lower surface of the substrate W from the lower surface nozzle 27 by simultaneously opening the sulfuric acid valve 141 and the hydrogen peroxide solution valve 142. Thus, the lower surface of the substrate W is also treated with the resist removing liquid (the liquid mixture of the sulfuric acid and the hydrogen peroxide solution), whereby a small amount of a resist adhering on the lower surface of the substrate W can be removed.

After the treatment with the resist removing liquid, the sulfuric acid valve 141 and the hydrogen peroxide solution valve 142 are closed, and the nitrogen gas valve 144 is opened, whereby the resist removing liquid remaining in the treatment liquid supply pipe 26 is completely ejected from the lower surface nozzle 27. Then, the nitrogen gas valve 144 is closed, and the deionized water valve 143 is opened, whereby the deionized water is supplied onto the lower surface of the substrate W from the treatment liquid supply pipe 26 through the lower surface nozzle 27. Thus, the rinsing process is performed on the lower surface of the substrate W.

The rinsing process is performed on the upper surface of the substrate W in substantially the same manner. That is, after the foreign matter removing process is performed on the upper surface of the substrate W by supplying the resist removing liquid from the bifluid nozzle 50 onto the upper surface of the substrate W, the sulfuric acid valve 89 and the hydrogen peroxide solution valve 92 are closed, and the nitrogen gas valve 96 is opened. Thus, the resist removing liquid remaining in the treatment liquid supply pipe 7 is completely ejected from the bifluid nozzle 50. Thereafter, the nitrogen gas valve 96 is closed, and the deionized water valve 95 is opened, whereby the deionized water is supplied from the bifluid nozzle 50 toward the upper surface of the substrate W for performing the rinsing operation on the upper surface of the substrate W. If the nitrogen gas valve 13 is opened to supply the nitrogen gas from the nitrogen gas pipe 8 into the bifluid nozzle 50 at this time, a physical action provided by the impact of liquid droplets can be added to the cleaning effect.

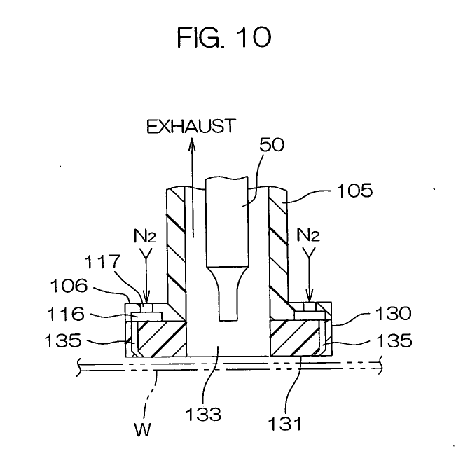

FIG. 10 is a fragmentary sectional view for explaining the construction of a variation of the embodiment shown in FIG. 9. Instead of the shield plate 110 shown in FIG. 9, a shield plate 130 having a flat substrate opposing surface 131 parallel to the upper surface of the substrate W held by the spin chuck 21 is connected to the lower edge of the exhaust pipe 105 in this embodiment. Since the substrate opposing surface 131 is parallel to the upper surface of the substrate W, a space defined around the bifluid nozzle 50 is limited thereby to be effectively shielded when the substrate opposing surface 131 is located in proximity to the upper surface of the substrate W.

The shield plate 130 has a nitrogen gas supply port 135 extending through a peripheral portion thereof in communication with the annular groove 116 formed in the flange 106 of the exhaust pipe 105. The nitrogen gas supply port 135 has a sectional shape such that its lower portion is inwardly inclined. With this arrangement, the nitrogen gas ejected from the nitrogen gas supply port 135 flows toward the suction port 133 through a limited space defined between the substrate opposing surface 131 and the upper surface of the substrate W. Thus, the leakage of the vapor and the liquid droplets outside the shield plate 130 can advantageously be suppressed, and the vapor and the liquid droplets are sucked away from the vicinity of the substrate W through the exhaust pipe 105.

The nitrogen gas supply port 135 may include a plurality of nitrogen gas supply ports arranged in circumferentially spaced relation in the peripheral portion of the shield plate 130, but is preferably provided as an annular slit-shaped opening circumferentially continuously extending along the peripheral portion of the substrate opposing surface 131.

While the three embodiments of the present invention have thus been described, the invention may be embodied in any other ways. In the embodiments described above, the foreign matter remaining on the substrate W having been subjected to the ashing process in the ashing section ASH is removed. However, the second and third embodiments may be employed for a resist film stripping process for stripping away the resist film from the substrate W with the use of the resist removing liquid without performing the ashing process. In this case, there is no need to provide the ashing section ASH in the substrate treating apparatus.

In the embodiments described above, the deionized water and the resist removing liquid are employed as the treatment liquid to be supplied to the bifluid nozzle 50, but the treatment liquid is not limited thereto. Any other types of treatment liquids may be employed according to the type of the substrate W.

In the embodiments described above, the nitrogen gas is employed as the gas to be supplied to the bifluid nozzle 50, but the gas is not limited thereto. Any other inert gases (e.g., argon) and air may be employed as the gas.

While the present invention has been described in detail by way of the embodiments thereof, it should be understood that the foregoing disclosure is merely illustrative of the technical principles of the present invention but not limitative of the same. The spirit and scope of the present invention are to be limited only by the appended claims.

This application corresponds to Japanese Patent Application No. 2003-184524 filed with the Japanese Patent Office on Jun. 27, 2003, and Japanese Patent Application No. 2004-100548 filed with the Japanese Patent Office on Mar. 30, 2004, the disclosure of which is incorporated herein by reference.

What is claimed is:

1. A foreign matter removing apparatus for removing foreign matter remaining on a surface of a substrate after ashing of a resist film formed on the substrate, the apparatus comprising:
a substrate rotating mechanism which holds and rotates the substrate; and
a fluid mixture supplying mechanism which generates a fluid mixture by mixing a treatment liquid and a gas, and supplies the fluid mixture to the surface of the substrate held by the substrate rotating mechanism.

2. A foreign matter removing apparatus as set forth in claim 1, wherein the treatment liquid is deionized water.

3. A foreign matter removing apparatus as set forth in claim 1, wherein the treatment liquid is a resist removing liquid.

4. A foreign matter removing apparatus as set forth in claim 3, wherein the resist removing liquid is a liquid mixture of sulfuric acid and a hydrogen peroxide solution.

5. A foreign matter removing apparatus as set forth in claim 3,
wherein the fluid mixture supplying mechanism includes a bifluid nozzle which spouts a fluid mixture of the resist removing liquid and the gas,
the foreign matter removing apparatus further comprising a liquid droplet collecting mechanism which has a suction port provided adjacent the bifluid nozzle and collects liquid droplets or a vapor resulting from the fluid mixture spouted from the bifluid nozzle by suction through the suction port.

6. A foreign matter removing apparatus as set forth in claims, wherein the liquid droplet collecting mechanism includes an exhaust hood which surrounds the bifluid nozzle with the suction port being disposed in opposed relation to the substrate held by the substrate rotating mechanism, and a suction mechanism which sucks ambient air in the exhaust hood together with the liquid droplets.

7. A foreign matter removing apparatus as set forth in claim 5,
wherein the liquid droplet collecting mechanism includes a shield plate having a substrate opposing surface provided with the suction port to be brought into closely opposed relation to the substrate held by the substrate rotating mechanism,
wherein the bifluid nozzle extends through the suction port to face toward the substrate held by the substrate rotating mechanism.

8. A foreign matter removing apparatus as set forth in claim 7,
wherein the substrate to be held by the substrate rotating mechanism is a round substrate,
wherein the shield plate has a round shape smaller than the round substrate held by the substrate rotating mechanism.

9. A foreign matter removing apparatus as set forth in claim 7, wherein the substrate opposing surface is a flat surface to be brought into proximity to the substrate held by the substrate rotating mechanism.

10. A foreign matter removing apparatus as set forth in claim 7, wherein the substrate opposing surface is a concave surface which is concaved away from the substrate held by the substrate rotating mechanism.

11. A foreign matter removing apparatus as set forth in claim 7,
wherein the shield plate has an inert gas supply port provided in a peripheral portion thereof for supplying an inert gas onto the substrate held by the substrate rotating mechanism,
the foreign matter removing apparatus further comprising an inert gas supplying mechanism which supplies the inert gas into the inert gas supply port.

12. A foreign matter removing apparatus as set forth in claim 11, wherein the inert gas supplying mechanism supplies a hot inert gas into the inert gas supply port.

13. A foreign matter removing apparatus as set forth in claim 5, further comprising:
a treatment liquid mixing mechanism which mixes sulfuric acid and a hydrogen peroxide solution; and
a stirring mechanism which stirs a mixture of the sulfuric acid and the hydrogen peroxide solution provided by the treatment liquid mixing mechanism,
wherein the mixture of the sulfuric acid and the hydrogen peroxide solution stirred by the stirring mechanism is supplied as the resist removing liquid into the bifluid nozzle.

14. A foreign matter removing apparatus as set forth in claim 5, wherein the gas to be supplied to the bifluid nozzle is a gas heated at a temperature higher than a room temperature.

15. A foreign matter removing apparatus as set forth in claim 1, wherein the fluid mixture supplying mechanism includes a bifluid nozzle of an external mixing type, which comprises a treatment liquid flow channel through which the treatment liquid flows, a gas flow channel through which the gas flows, a treatment liquid outlet port having an opening in communication with the treatment liquid flow channel, and a gas outlet port provided adjacent the treatment liquid outlet port and having an opening in communication with the gas flow channel.

16. A foreign matter removing apparatus as set forth in claim 1, wherein the fluid mixture supplying mechanism includes a bifluid nozzle of an internal mixing type, which comprises a treatment liquid flow channel through which the treatment liquid flows, a gas flow channel through which the gas flows, a mixing chamber provided in communication with the treatment liquid flow channel and the gas flow channel for generating the fluid mixture, and a fluid mixture outlet port having an opening in communication with the mixing chamber for spouting the fluid mixture.

17. A foreign matter removing apparatus for stripping away a resist film as foreign matter from a substrate, the apparatus comprising:
a substrate rotating mechanism which holds and rotates the substrate;
a bifluid nozzle which generates a fluid mixture by mixing a resist removing liquid and a gas, and spouts the fluid mixture toward the substrate held by the substrate rotating mechanism; and
a liquid droplet collecting mechanism which has a suction port provided adjacent the bifluid nozzle, and collects liquid droplets or a vapor resulting from the fluid mixture spouted from the bifluid nozzle by suction through the suction port.

18. A foreign matter removing apparatus as set forth in claim 17, wherein the liquid droplet collecting mechanism includes an exhaust hood which surrounds the bifluid nozzle with the suction port being disposed in opposed relation to the substrate held by the substrate rotating mechanism, and a suction mechanism which sucks ambient air in the exhaust hood together with the liquid droplets.

19. A foreign matter removing apparatus as set forth in claim 17,
wherein the liquid droplet collecting mechanism includes a shield plate having a substrate opposing surface provided with the suction port to be brought into closely opposed relation to the substrate held by the substrate rotating mechanism,
wherein the bifluid nozzle extends through the suction port to face toward the substrate held by the substrate rotating mechanism.

20. A foreign matter removing apparatus as set forth in claim 19,
wherein the substrate to be held by the substrate rotating mechanism is a round substrate,
wherein the shield plate has a round shape smaller than the round substrate held by the substrate rotating mechanism.

21. A foreign matter removing apparatus as set forth in claim 19, wherein the substrate opposing surface is a flat surface to be brought into proximity to the substrate held by the substrate rotating mechanism.

22. A foreign matter removing apparatus as set forth in claim 19, wherein the substrate opposing surface is a concave surface which is concaved away from the substrate held by the substrate rotating mechanism.

23. A foreign matter removing apparatus as set forth in claim 19,
wherein the shield plate has an inert gas supply port provided in a peripheral portion thereof for supplying an inert gas onto the substrate held by the substrate rotating mechanism,
the foreign matter removing apparatus further comprising an inert gas supplying mechanism which supplies the inert gas into the inert gas supply port.

24. A foreign matter removing apparatus as set forth in claim 23, wherein the inert gas supplying mechanism supplies a hot inert gas into the inert gas supply port.

25. A foreign matter removing apparatus as set forth in claim 17, further comprising:
a treatment liquid mixing mechanism which mixes sulfuric acid and a hydrogen peroxide solution; and
a stirring mechanism which stirs a mixture of the sulfuric acid and the hydrogen peroxide solution provided by the treatment liquid mixing mechanism,
wherein the mixture of the sulfuric acid and the hydrogen peroxide solution stirred by the stirring mechanism is supplied as the resist removing liquid into the bifluid nozzle.

26. A foreign matter removing apparatus as set forth inclaim 17, wherein the gas to be supplied into the bifluid nozzle is a gas heated at a temperature higher than a room temperature.

27. A foreign matter removing apparatus as set forth in claim 17, wherein the bifluid nozzle is a bifluid nozzle of an external mixing type, which comprises a treatment liquid flow channel through which the resist removing liquid flows, a gas flow channel through which the gas flows, a treatment liquid outlet port having an opening in communication with the treatment liquid flow channel, and a gas outlet port provided adjacent the treatment liquid outlet port and having an opening in communication with the gas flow channel.

28. A foreign matter removing apparatus as set forth in claim 17, wherein the bifluid nozzle is a bifluid nozzle of an internal mixing type, which comprises a treatment liquid flow channel through which the resist removing liquid flows, a gas flow channel through which the gas flows, a mixing chamber provided in communication with the treatment liquid flow channel and the gas flow channel for generating the fluid mixture, and a fluid mixture outlet port having an opening in communication with the mixing chamber for spouting the fluid mixture.

29. A substrate treating apparatus, comprising:
an ashing apparatus which performs an ashing process for ashing a resist film formed on a surface of a substrate;
a foreign matter removing apparatus which removes foreign matter from the surface of the substrate having been subjected to the ashing process by the ashing apparatus; and
a transport mechanism which transports the substrate between the ashing apparatus and the foreign matter removing apparatus,
the ashing apparatus, the foreign matter removing apparatus and the transport mechanism being provided integrally in the substrate treating apparatus.

30. A substrate treating method, comprising the steps of:
performing an ashing process for ashing a resist film formed on a surface of a substrate;
holding and rotating the substrate having been subjected to the ashing process; and
generating a fluid mixture by mixing a treatment liquid and a gas, and supplying the fluid mixture onto the surface of the rotating substrate.

31. A substrate treating method for stripping away a resist film from a surface of a substrate, the method comprising the steps of:
holding and rotating the substrate by means of a substrate rotating mechanism;
mixing a resist removing liquid and a gas by a bifluid nozzle to generate a fluid mixture, and spouting the fluid mixture from the bifluid nozzle toward the surface of the substrate held by the substrate rotating mechanism simultaneously with the substrate rotating step; and
positioning a suction port of a liquid droplet collecting mechanism in a vicinity of the bifluid nozzle, and collecting liquid droplets or a vapor resulting from the fluid mixture spouted from the bifluid nozzle through the suction port.
